(19) United States
(12) Patent Application Publication
(10) Pub. No.: US 2026/0221661 A1
(43) Pub. Date: Jul. 30, 2026

(54) BIDIRECTIONAL ANTENNA

(71) Applicants: STMicroelectronics International N.V., Geneva (CH); Centre National De La Recherche Scientifique, Paris (FR); Institut Polytechnique de Bordeaux, Talence (FR); Universite de Bordeaux, Bordeaux (FR)

(72) Inventors: Nicolas ROBIN, Grenoble (FR); Anthony GHIOTTO, Begles (FR)

(73) Assignees: STMicroelectronics International N.V., Geneva (CH); Centre National De La Recherche Scientifique, Paris (FR); Institut Polytechnique de Bordeaux, Talence (FR); Universite de Bordeaux, Bordeaux (FR)

(21) Appl. No.: 19/443,352

(22) Filed: Jan. 8, 2026

(30) Foreign Application Priority Data
Jan. 27, 2025 (FR) FR2500837

(51) Int. Cl. H01Q 13/10; H01Q 1/22

(52) U.S. Cl. CPC H01Q 13/10; H01Q 1/2283

(57) ABSTRACT

An antenna includes a first slot, a second slot parallel to the first slot, a third slot, and a fourth slot being parallel to the third slot. The first and second slots are arranged symmetrically with respect to a first axis coupling the middles of the third and fourth slots.

### PRIORITY CLAIM

This application claims the priority benefit of French Application for Patent No. FR2500837, filed on Jan. 27, 2025, the content of which is hereby incorporated by reference in its entirety to the maximum extent allowable by law.

### TECHNICAL FIELD

The present disclosure generally relates to electronic systems and devices, and their means of communication. More particularly, the present disclosure relates to the formation of antennas that enable simultaneous transmission and reception of signals at the same frequencies.

### BACKGROUND

The use of antennas to transmit data in wireless fashion has been widespread for many years. There exist a multitude of types of antennas having different characteristics and enabling data to be sent by using signals of various frequencies.

The use of antennas to transmit data wirelessly has been widespread for many years. There are a multitude of types of antennas with different characteristics, enabling data to be sent using signals of various frequencies.

Currently, there are antennas, or antenna systems, configured to simultaneously transmit and receive signals in the same frequency band; these are called bidirectional antennas.

It would be desirable to improve, at least in part, certain aspects of known bidirectional antennas.

There is a need for more compact bidirectional antennas.

There is a need for bidirectional antennas with reduced internal interference between transmission and reception.

There is a need to overcome all or part of the disadvantages of known bidirectional antennas.

### SUMMARY

An embodiment provides a more compact bidirectional antenna.

An embodiment provides a bidirectional antenna that exhibits less internal interference between transmission and reception.

An embodiment provides an antenna with: a first slot; a second slot parallel to the first slot; a third slot; and a fourth slot parallel to the third slot, wherein the first and second slots are arranged symmetrically with respect to a first axis connecting the centers of the third and fourth slots.

Another embodiment provides a wireless communication method using an antenna having: a first slot configured to transmit a first signal; a second slot configured to transmit the first signal phase-shifted by 180°, the second slot being parallel to the first slot; a third slot configured to receive a second signal; a fourth slot configured to receive the second signal phase-shifted by 180°, the fourth slot being parallel to the third slot, wherein the first and second slots are arranged symmetrically with respect to a first axis connecting the centers of the third and fourth slots.

In one embodiment, the first, second, third, and fourth slots have a rectangular shape.

In one embodiment: the first slot is configured to transmit a first signal; the second slot is configured to transmit the first signal phase-shifted by 180°, the second slot being parallel to the first slot; the third slot is configured to receive a second signal; and the fourth slot is configured to receive the second signal phase-shifted by 180°, the fourth slot being parallel to the third slot.

In one embodiment, the first and second slots have the same dimensions.

In one embodiment, the third and fourth slots have the same dimensions.

In one embodiment, the first, second, third, and fourth slots all have the same dimensions.

In one embodiment, the third and fourth slots are arranged symmetrically with respect to a second axis connecting the centers of the first and second slots.

In one embodiment, the first, second, third, and fourth slots are each topped by a first metal layer.

In one embodiment, the first metal layer has a rectangular shape.

In one embodiment, the first, second, third, and fourth slots are each topped by a stack of second metal layers.

In one embodiment, the stack has a rectangular shape.

Another embodiment provides an electronic device having an antenna as described above.

Another embodiment provides a wireless communication system having a first device as described above and a second device as described above.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows a diagram illustrating a bidirectional wireless communication system;

FIG. 2 shows a perspective view of an assembly comprising a printed circuit board, an integrated circuit in a package, and an embodiment of an antenna;

FIG. 3 shows a cross-sectional view of an assembly comprising a printed circuit board, an integrated circuit in a package, and an embodiment of an antenna;

FIG. 4 shows a top view of an embodiment of an antenna on a package; and

FIG. 5 shows a diagram illustrating the electric field emitted by the embodiment of FIG. 4.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only those steps and elements that are useful for understanding the described embodiments have been shown and are described in detail.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

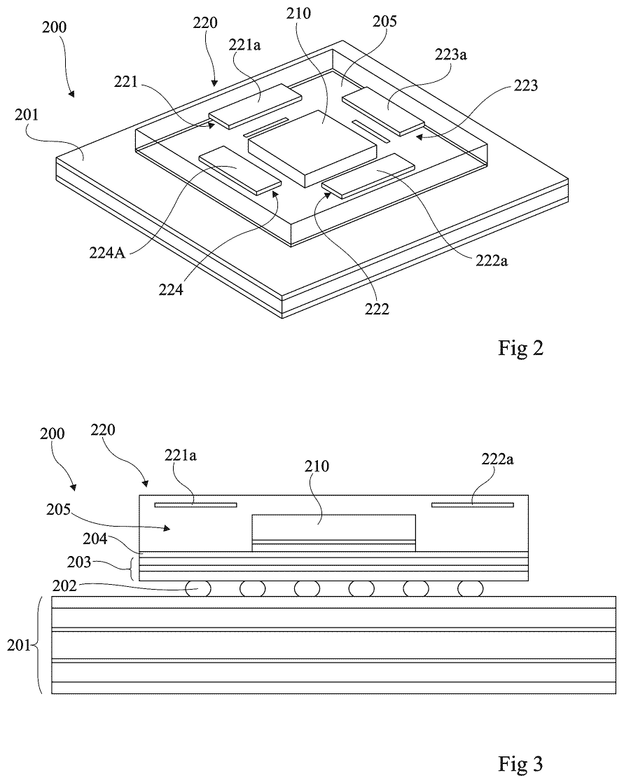

The embodiments described hereafter concern an antenna for implementing a wireless communication method, the antenna being configured to simultaneously transmit and receive signals of the same or similar frequencies. Such an antenna is intended to implement bidirectional communications on the same frequency band (In-Band Full-Duplex Communications). A shortcoming of antennas of this type is that internal interference, generally due to the proximity of the signal transmit and receive chains, may interfere with the functioning of the communication. The embodiments described herein concern an antenna comprising four elementary antennas, formed by slots, two of which are used for signal transmission and the other two for signal reception. To overcome interference problems, these embodiments use a first transmit antenna to transmit a signal and a second transmit antenna to transmit the same signal, but phase-shifted by 180°. Similarly, a first receive antenna is configured to receive a signal, and a second receive antenna is configured to receive the same signal but phase-shifted by 180°. The assembly and specific arrangement of these antennas are described in relation to FIGS. 2 to 5. These embodiments also concern a wireless communication method using such an antenna.

Furthermore, the embodiments described hereafter are particularly configured for any wireless communication device, whether or not the communication is high-speed. These embodiments may, for example, be used to implement near-field communications (NFC), ultra-wideband (UWB) communications, or communications using fourth-or fifth-generation cellular networks.

Additionally, the above-described embodiments are particularly suited for use in any type of industrial market where antennas are needed, for example, to implement wireless communication. More particularly, such an antenna may be intended for: the automotive industry, for example in the field of automotive electrification or advanced driver assistance systems (ADAS); the industrial sector, for example, in green energy, infrastructure electrification, the Internet of Things (IoT), and smart homes, where electricity and energy consumption and data exchange are key elements; the personal electronics industry, for example in mobile telephony and the Internet of Things (IoT), as well as in high-speed interfaces; and the communications equipment, computers, and peripherals industry, for example in infrastructures and data centers, and in low earth orbit (LEO) satellites.

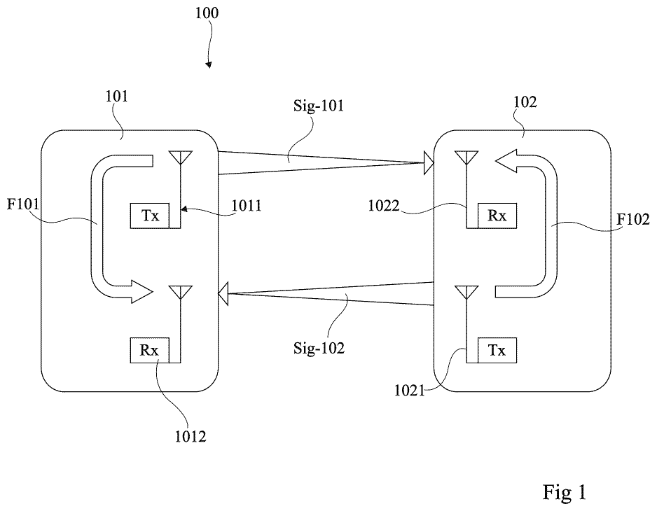

FIG. 1 is a diagram illustrating a wireless communication system 100.

System 100 comprises two electronic devices 101 and 102 configured to communicate with each other by implementing wireless communication. More particularly, device 101 is configured to transmit to device 102 a signal Sig-101, and device 102 is configured to receive this signal Sig-101. Similarly, device 102 is configured to transmit to device 101 a signal Sig-102, and device 101 is configured to receive this signal Sig-102.

To implement this wireless communication, devices 101 and 102 are both equipped with an antenna system formed of a transmit chain and a receive chain.

For example, device 101 comprises a transmit chain 1011 (TX) and a receive chain 1012 (RX). Transmit chain 1011 is configured to transmit signal Sig-101 and comprises, for this purpose, transmit circuits and an antenna. Receive chain 1012 is configured to transmit signal Sig-102 and comprises, for this purpose, receive circuits and an antenna. In another example, the transmit and receive chains 1011 and 1012 may share the same antenna.

Similarly, device 102 comprises a transmit chain 1021 (TX) and a receive chain 1022 (RX). Transmit chain 1021 is configured to transmit signal Sig-102 and comprises, for this purpose, transmit circuits and an antenna. Receive chain 1022 is configured to transmit signal Sig-101 and comprises, for this purpose, receive circuits and an antenna. In another example, the transmit and receive chains 1021 and 1022 may share the same antenna.

A problem with systems of the type of system 100 is that the transmit and receive chains of devices 101 and 102 may interfere with each other. Indeed, a transmit chain, by its nature, transmits high-amplitude signals, and the receive chain, by its nature, is configured to capture low-amplitude signals. The signals transmitted by the transmit chain can thus, in part, be captured by the receive chain and create interference that may adversely affect the smooth operation of the wireless communication. The embodiments described in relation to FIGS. 2 to 5 concern an antenna that limits internal interference for an electronic device of the type of devices 101 or 102.

FIGS. 2 and 3 show an embodiment of an electronic device 200 of the type of devices 101 and 102 described in relation to FIG. 1. More particularly, FIG. 2 is a perspective view of device 200, and FIG. 3 is a cross-sectional view of device 200.

For example, electronic device 200 is formed from a support 201, which may be a printed circuit board. Support 201 may be a stack of electrically insulating or electrically conductive layers. In a specific example, support 201 is formed by a stack comprising metallization levels separated by a first electrically insulating layer, for example, having a thickness of about 80 μm, a second electrically insulating core layer, for example, having a thickness of about 300 μm, and a third electrically insulating layer, for example, having a thickness of about 80 μm.

Electronic device 200 may comprise an integrated circuit 210 formed on a second support 203 forming part of a package attached to support 201 via conductive balls 202. This second support may be a stack of electrically insulating or electrically conductive layers. For example, support 203 comprises: an insulating layer having a thickness of about 75 μm; a conductive layer; and an insulating layer having a thickness of about 50 μm.

In one embodiment, support 203 is covered by an electrically conductive layer 204 in which a portion of an antenna system 220 surrounding integrated circuit 201 is formed. For example, layer 204 has a thickness of about 25 μm. Furthermore, the conductive layer of stack 203 may be used as an excitation element for the slots forming the antennas of the antenna system. In another example, transmission lines may be formed in metallization levels of the package and used as excitation elements for the slots forming the antennas of the antenna system.

In one embodiment, antenna system 220 may be fully integrated into the package protecting integrated circuit 210. In particular, the slots may all be formed in metallization levels of the package. In another embodiment, antenna system 220 is completely separate from the package.

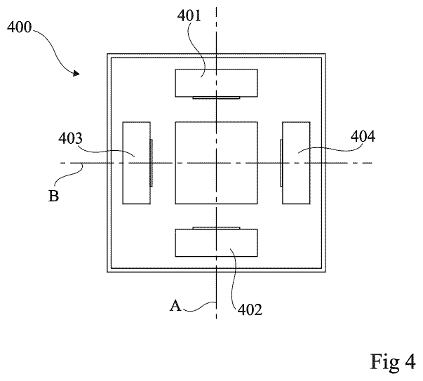

In one embodiment, antenna system 220 comprises four antennas 221, 222, 223, and 224 arranged at the periphery of integrated circuit 210. The rules for placing antennas 221 to 224 are described in further detail in relation to FIG. 4. Each antenna 221 to 224 is formed from a slot in conductive layer 204. Thus, antennas 221 to 224 can be considered slot antennas.

In an alternative embodiment, each antenna 221, 222, 223, and 224 may optionally comprise a metal layer 221a, 222a, 223a, 224a arranged at a distance from the slot, also called patch 221a, 222a, 223a, 224a. This metal layer 221a, 222a, 223a, 224a may be formed in a package 205 surrounding integrated circuit 210. For example, this metal layer 221a, 222a, 223a, 224a is a copper layer, having a thickness of about 20 μm. In another example, this metal layer 221a, 222a, 223a, 224a is a stack of metal layers. When the antenna is formed by a slot and a metal layer, it can be called a slot-coupled patch antenna. When the antenna is formed of a slot and a stack of metal layers, it can be called a slot-coupled multi-patch antenna. In one embodiment, in top view, patches 221a, 222a, 223a, 224a have a rectangular shape.

The various types of antenna described above are well known to those skilled in the art, and adapting their dimensions to the frequency of the exchanged signals is considered routine. It should be noted that the use of slot antennas has far fewer dimensional and shape constraints than other types of antennas known to date. The use of such antennas thus has the advantage of enabling a more compact antenna system.

In one embodiment, antennas 221 and 222 are signal-transmit antennas and are arranged opposite each other. Antennas 221 and 222 are arranged parallel to each other. Antenna 221 is configured to transmit a first signal, and antenna 222 is configured to transmit a second signal corresponding to the first signal phase-shifted by 180°.

In one embodiment, antennas 223 and 224 are signal-receive antennas and are arranged opposite each other. Antennas 223 and 224 are arranged parallel to each other. Antenna 223 is configured to receive a first signal, and antenna 224 is configured to receive a second signal corresponding to the first signal phase-shifted by 180°.

Another advantage of this embodiment is that the use of a double transmit antenna and a double receive antenna limits interference within the antenna system.

It should be noted that the present disclosure also concerns a method of implementing a wireless communication method using an antenna according to an embodiment.

FIG. 4 is a top view of an example of an antenna 400 of the type of antenna system 220 described in relation to FIGS. 2 and 3.

As previously described, antenna 400 comprises four antennas 401, 402, 403, and 404. In one embodiment, antennas 401 and 402 are signal-transmit antennas and are arranged opposite each other. Antennas 401 and 402 are arranged parallel to each other. Antenna 401 is configured to transmit a first signal, and antenna 402 is configured to transmit a second signal corresponding to the first signal phase-shifted by 180°. In one embodiment, antennas 403 and 404 are signal-receive antennas and are arranged opposite each other. Antennas 403 and 404 are arranged parallel to each other. Antenna 403 is configured to receive a first signal, and antenna 404 is configured to receive a second signal corresponding to the first signal phase-shifted by 180°.

More particularly, and still according to one embodiment, antennas 401 and 402 are arranged symmetrically with respect to an axis B (shown in dotted lines in FIG. 4) connecting the center of antenna 403 to the center of antenna 404.

Optionally, in one embodiment, antennas 403 and 404 are arranged symmetrically with respect to an axis A (shown in dotted lines in FIG. 4) connecting the center of antenna 401 to the center of antenna 402.

In one embodiment, antennas 401 to 404 are inscribed within a relatively rectangular or even a relatively square shape.

In one embodiment, transmit antennas 401 and 402 have the same dimensions. Receive antennas 403 and 404 also have the same dimensions. In a preferred embodiment, antennas 401 to 404 all have the same dimensions.

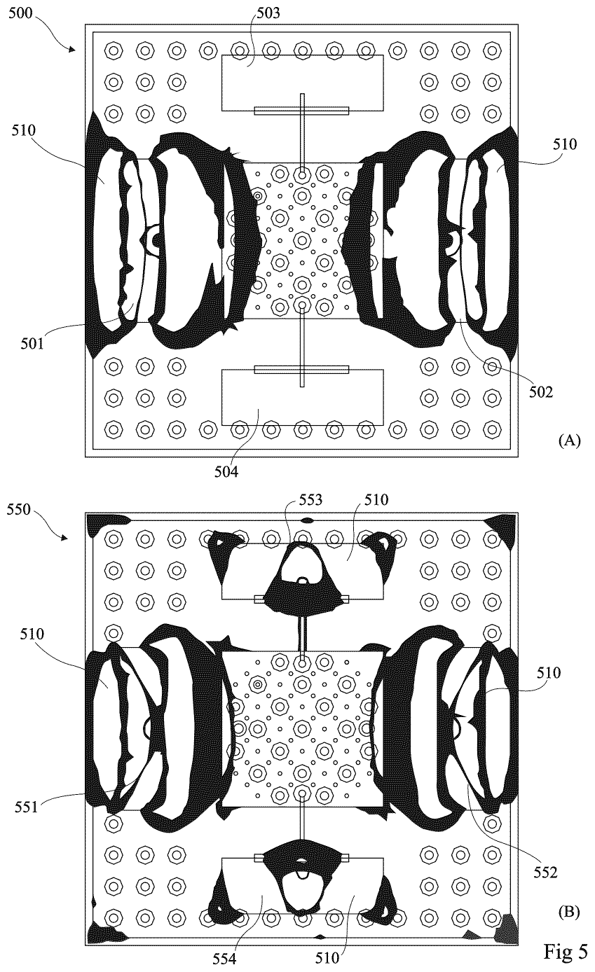

FIG. 5 comprises two diagrams (A) and (B) illustrating the electric field emitted by the embodiment of an antenna of FIG. 4 and by another antenna.

More particularly, view (A) of FIG. 5 shows a top view of an antenna 500 of the type of antenna 400 described in relation to FIG. 4, and surfaces 510 representing the electric fields within antenna 400 are shown. For example, antenna 501 is of the type of antenna 401 described in relation to FIG. 4. Antenna 502 is of the type of antenna 402 described in relation to FIG. 4. Antenna 503 is of the type of antenna 403 described in relation to FIG. 4. Antenna 504 is of the type of antenna 404 described in relation to FIG. 4.

View (B) of FIG. 5 shows a top view of an antenna 550 structurally similar to antenna 500, but only transmitting on its two transmit antennas the signal to be transmitted, without transmitting the signal phase-shifted by 180°. Thus, this antenna 550 comprises two transmit antennas 551 and 552 and two receive antennas 553 and 554. These diagrams show that the receive antennas 503 and 504 of antenna 500 are not affected by signals transmitted by transmit antennas 501 and 502, while the receive antennas 553 and 554 of antenna 550 are affected by the signals transmitted by transmit antennas 551 and 552. This demonstrates the advantage of these embodiments of sending both the signal to be transmitted and the signal phase-shifted by 180°.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given above.

1. An antenna, comprising:
a first slot;
a second slot parallel to the first slot;
a third slot; and
a fourth slot being parallel to the third slot;
wherein said first and second slots are arranged symmetrically with respect to a first axis coupling middles of the third and fourth slots, and wherein said first, second, third, and fourth slots are each topped by a first metal layer that has a rectangular shape.

2. The antenna according to claim 1, wherein said first, second, third, and fourth slots have a rectangular shape.

3. The antenna according to claim 1, wherein said first and second slots are same in dimension.

4. The antenna according to claim 1, wherein said third and fourth slots are same in dimension.

5. The antenna according to claim 1, wherein said first, second, third, and fourth slots are same in dimension.

6. The antenna according to claim 1, wherein said third and fourth slots are arranged symmetrically with respect to a second axis coupling the middles of the first and second slots.

7. The antenna according to claim 1, wherein:
the first slot is configured to transmitting a first signal;
the second slot is configured to transmitting said first signal phase-shifted by 180°, said second slot being parallel to the first slot;
the third slot is configured to receiving a second signal; and
the fourth slot is configured to receiving said second signal phase-shifted by 180°, said fourth slot being parallel to the third slot.

8. The antenna according to claim 1, wherein said first, second, third, and fourth slots are each topped by a stack of second metal layers.

9. The antenna according to claim 8, wherein said stack has a rectangular shape.

10. An electronic device, comprising an antenna according to claim 1.

11. A wireless communication system, comprising a first device according to claim and a second device according to claim 10.

12. A method of wireless communication, comprising:
transmitting a first signal using a first slot of an antenna;
transmitting the first signal phase-shifted by 180° using a second slot of the antenna, the second slot being parallel to the first slot;
receiving a second signal at a third slot of the antenna; and
receiving the second signal phase-shifted by 180° at a fourth slot of the antenna, the fourth slot being parallel to the third slot,
wherein the first and second slots are arranged symmetrically with respect to a first axis connecting centers of the third and fourth slots.

13. The method of claim 12, further comprising:
arranging the third and fourth slots symmetrically with respect to a second axis connecting the centers of the first and second slots.

14. The method of claim 12, further comprising:
exciting each of the first, second, third, and fourth slots by coupling them to a metal layer, the metal layer being a stack of metal layers positioned above each slot, the stack having a rectangular shape.

15. The method of claim 12, further comprising:
integrating the antenna into a package of an electronic device.

16. The method of claim 12, wherein:
the transmissions and receptions are performed simultaneously to enable in-band full-duplex communication.

17. The method of claim 12, further comprising:
using the method in a wireless communication system comprising two electronic devices, each equipped with an antenna as recited in claim 12.

18. The method of claim 12, wherein:
the method is used for near-field communication (NFC), ultra-wideband (UWB) communication, or cellular communication.

19. The method of claim 12, further comprising:
operating the antenna in an environment where minimizing internal interference between transmission and reception is desired.
